(19) United States
(12) Patent Application Publication
(10) Pub. No.: US 2008/0040987 A1
(43) Pub. Date: Feb. 21, 2008

(54) Bat and bird removal and exclusion device

(76) Inventor: James Dreisacker, New Fairfield, CT (US)

Correspondence Address: HESLIN ROTHENBERG FARLEY & MESITI PC, 5 COLUMBIA CIRCLE, ALBANY, NY, 12203, US

(21) Appl. No.: 11/505,768

(22) Filed: Aug. 18, 2006

(51) Int. Cl. E04B 1/72; A01K 3/00

(52) U.S. Cl. 52/101

(57) ABSTRACT

A device for removing and excluding bats and birds from the exterior of a structure having a structural opening through which bats and birds enter and exit the interior, comprises a flange adapted to engage the structure about the structural opening and a cone extending from the flange and communicating with the interior of the structure through the structural opening at a wide, first end and with the outside atmosphere at a narrow, opposite end, the device being made of slippery material. The flange of the device may be made of soft pliable material. The cone of the device may be of oblong cross section and may be of flexible corrugated material. The entire device may be of a clear material.

### BACKGROUND OF THE INVENTION

1. Field of the Invention

This invention relates to the field of pest control and to devices for removing and excluding bats and birds that have found their way into a structure, in particular, a residence.

2. Description of the Prior Art

It is known that bats will enter the interior of a structure such as a house and through openings in the structure such as an attic vent, fascia boards, dryer vents, the corner of a dormer and the like. In the past draped deer netting, PVC pipe, wire mesh and bat traps were used for bat and bird removal and exclusion.

### SUMMARY

The primary object of the invention is a suitable and effective bat and bird removal and exclusion device.

Another object is such a device that is lightweight and easy to install and use and reusable.

These and other objects, features and advantages are accomplished in accordance with the teachings of the present invention, one illustrative embodiment of which comprises a device for removing and excluding bats and birds from the exterior of a structure having a structural opening through which bats and birds enter and exit the interior, that includes a flange adapted to engage the structure about the structural opening and a cone extending from the flange and communicating with the interior of the structure through the structural opening at a wide, first end and with the outside atmosphere at a narrow, opposite end, the device being made of slippery material. The flange of the device may be made of soft pliable material. The cone of the device may be of round or oblong cross section and may be of flexible corrugated material. The entire device may be of a clear material.

### BRIEF DESCRIPTION OF THE DRAWING

Other objects, features and advantages of the present invention will be apparent from the following detailed description and accompany drawing, wherein:

FIG. 1 is a side sectional view of a first embodiment off the device of the present invention;

FIG. 2 is a top view of the device of FIG. 1;

FIG. 3 is a perspective view of the flange of a second embodiment of the flange of the device of the present invention;

FIG. 4 is a perspective view of the device cone of the second embodiment, shown separately;

FIG. 5 is a side sectional view of a third alternate embodiment off the device of the present invention;

FIG. 6 is a top view of the device of FIG. 5;

FIG. 7 is a side sectional view of the flange of a fourth alternate embodiment off the device of the present invention;

FIG. 8 is a top view of the device of FIG. 7;

FIG. 9 is a side sectional view of a fifth embodiment of the present invention; and,

FIG. 10 is top view of the flange of the embodiment of the device of FIG. 9.

### DETAILED DESCRIPTION

The most common bats and birds that the device is intended to exclude in the northeast of the United States of America are the little brown bat, big brown bat, house sparrow, starling and blackbird. The inventions described herein are for the purpose of removing and excluding bats and/or birds from a structure.

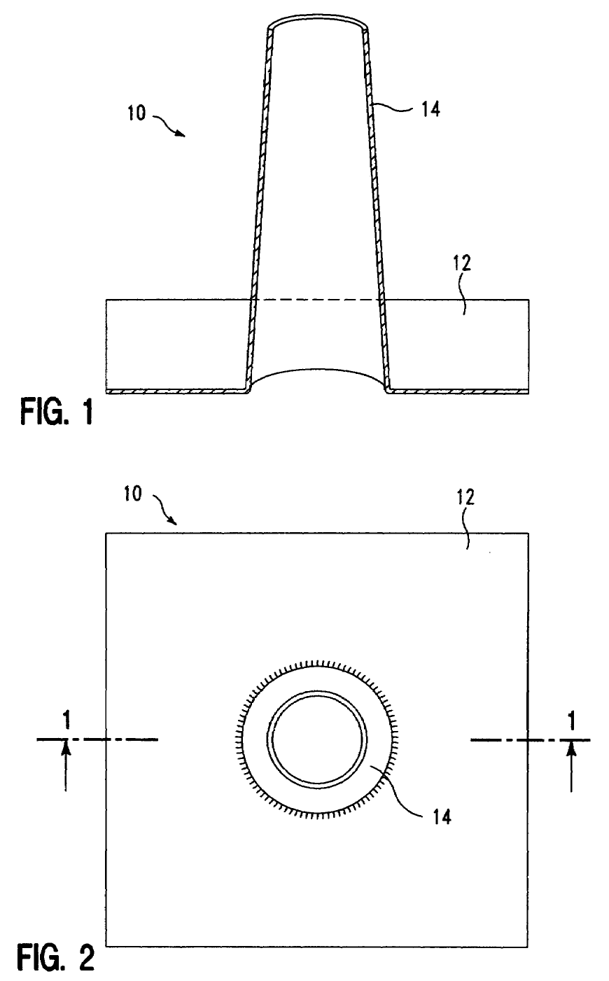

Referring now to FIGS. 1 and 2 of the drawing there is disclosed a device 10 for removing and excluding bats from the exterior of a structure. The device 10 is seen as including a flat flange portion 12. A tubular portion or cone 14 is formed integrally with and extends from the flange 12 for positioning over an opening in a structure or house. The device 10 is made as one piece over a mold.

The structural opening could be an attic vent, fascia boards, the corner of a dormer and the like.

The first end of the cone 12 at the flange 14 that is in communication with the interior of the structure has a wide opening, typically two inches in diameter, and a narrow opening at the opposite end that is in communication with the outside atmosphere, and is, typically one and a half inches in diameter. The size of the openings can be varied dependent upon predominant bat size in the area where the cone is to be used. The tapered design of the cone 14 also allows the cones to be stacked one on top of the other for shipping purposes and compact packaging.

Typically the flange 12 is six to seven inches square while the cone 14 is six to seven inches high.

The flange 12 is placed against the structure over the structural opening. One can use staples, duct tape, screws or silicone caulk, to position the cone 14 over the structural opening. It can be custom fit to whatever opening there is in the structure. The flange 12, being of somewhat hard plastic or, alternatively a soft vinyl, can be trimmed to size and can be manipulated into differing shapes and, if rigid, with some effort on the part of the user.

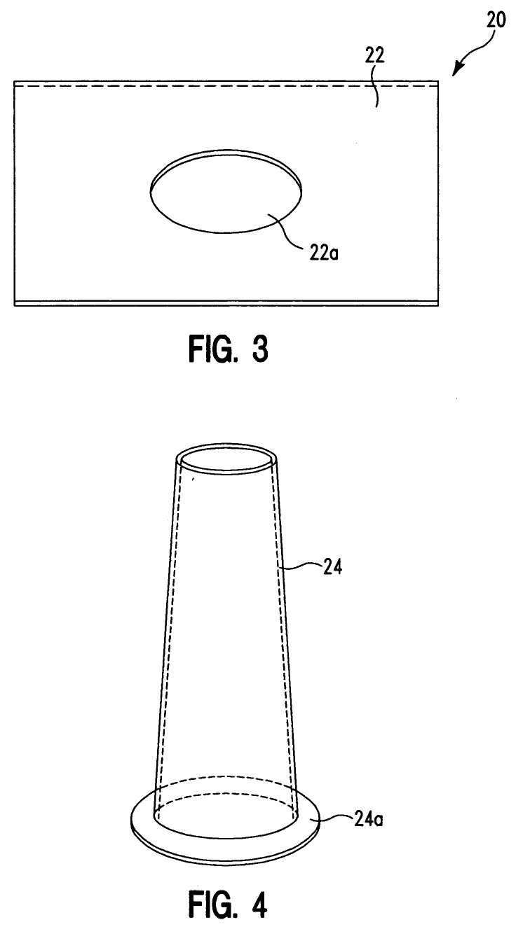

The device 10 allows a bat to fly out of the interior of the structure and prevents its return. The surface of the material for the cone 14 is slippery so that the bird or bat cannot easily grab onto the device 10. The material is clear so as to be non-obtrusive. A second embodiment, for both bats and birds, is shown in FIGS. 3 and 4. In this embodiment the device 20 is provided with a separate flange 22 and cone 24.

The flange 22 has a central opening 22a and is of a soft vinyl material. The cone 24, of a rigid plastic material, is provided with an annular portion around its base at 24a. The annular portion 24a allows the flange 22 to seat properly and prevents the flange 22 from sliding off the cone. In normal applications, the cone 24 is pressure fit to the flange 22. The flange 22 is cut undersized to slide over the cone 24. However, the cone 24 can be used alone and in this sense the annular portion 24a functions as a flange.

Use of a soft, vinyl material for the flange 22, allows use of the device 20 on multiple surfaces and makes the device more adaptable to cover a wide range of areas where bats or birds are exiting the structure. The flange 22 will basically mold itself around the surface to which it is applied. Thickening the material will add durability.

A more rigid material can be used but takes more work to manipulate the flange to fit a specific location.

A typical material used for the cone 24 is, for example, P.E.T.G. It is weather resistant, durable and doesn't break down.

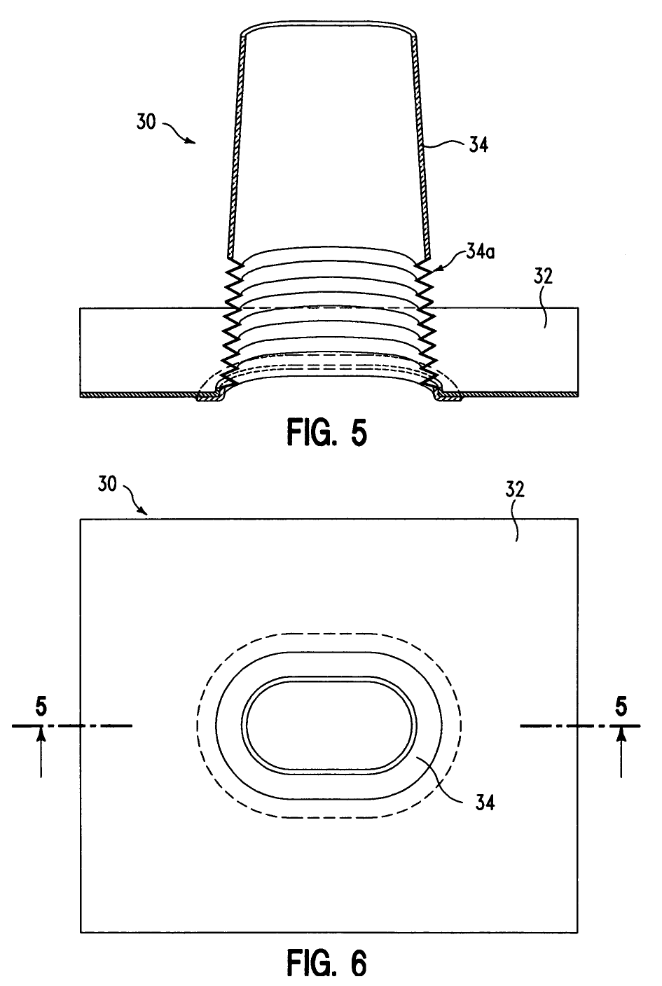

A third embodiment of the invention is shown in FIGS. 5 and 6. In this embodiment the device 30 has a flange 32 of soft vinyl material as in the embodiment of FIGS. 3 and 4. This allows for trimming the flange to desired shape and size. The cone 34 is of somewhat rigid material, also as in the embodiment of FIGS. 3 and 4. The cone 34 is of oblong cross section. Typically, the opening at the flange 32 measures two and a half inches by one inch while at the opposite end the opening is one and a half inches by three quarters of an inch. It is particularly useful in crevice areas, like sides of chimneys or corners of soffits and when attempting to rid a structure of bats. Also, multiple oblong cones are easily stacked.

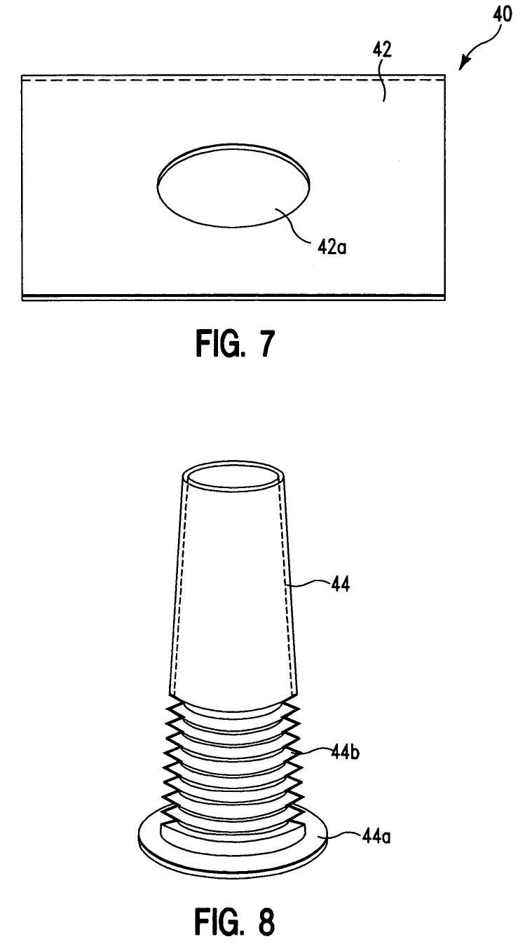

In the embodiment depicted in FIG. 5, the cone 34 may be a smooth member, but as depicted, the cone is shown as having a bellows portion 34a at its base. Whether the cone has a bellows portion or not, both embodiments allow the user to wedge the cone into a hole, but the embodiment depicted allows even greater flexibility of positioning since the cone's bellows portion 34a allows for even greater flexibility in positioning. A fourth embodiment of the invention is shown in FIGS. 7 and 8. The device 40 is similar to the embodiment shown in FIGS. 3 and 4 with flange 42 and flange opening 42a and cone 44 with annular portion 44a, except that the cone 44 is provided with a bellows-like portion, that is of flexible, corrugated material, bendable to adjust to exit points of the structure and allowing for installation at any angle.

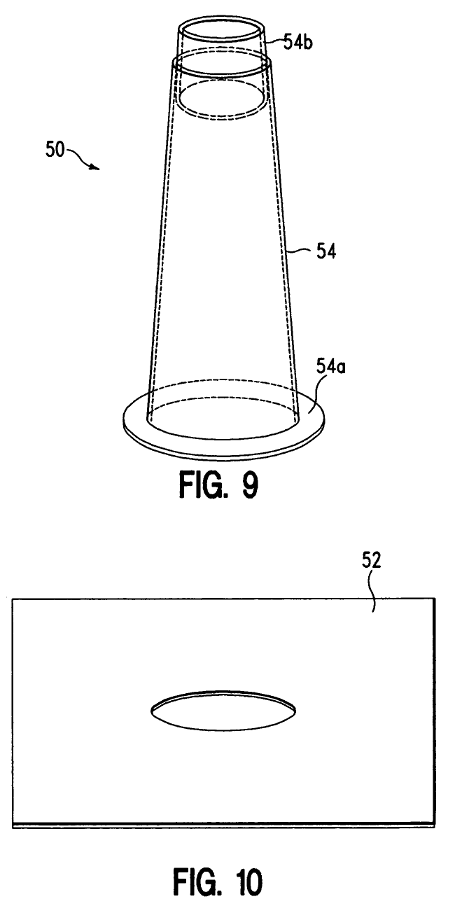

A fifth embodiment of the invention is shown in FIGS. 9 and 10. The device includes flange 52 and cone 54 with annular portion 54a. In a typical embodiment the flange 42 is six inches on a side, and the cone 44 is five and seven eights high with an opening at the flange 42 of two and a quarter inches and one and a quarter inches at the opposite end. Additionally, a frusto-conical shaped cone 54b is inserted into the end of the cone for reducing the size of the opening at the smaller end. This allows for a tighter opening and would prevent re-entry by smaller birds such as sparrows that could possibly re-enter with the larger opening.

Once all bats and/or birds have exited a house or structure, the cone may be removed and the entry point for the bats and/or birds is sealed with a sealant foam, silicone or wire mesh to prevent re-entry.

The present invention is superior to prior art devices in that it is simple to install, lightweight, weatherproof, recyclable and, where low profile clear plastic is used, is not visible from a distance.

It should be obvious that changes, additions and omissions may be made in the details and arrangement of parts without departing from the spirit and scope of the invention as hereinafter claimed.

What is claimed is:

1. A device for removing and excluding bats and birds from the exterior of a structure having a structural opening through which bats and birds enter and exit the interior, the device comprising:
a flange adapted to engage the structure about the structural opening; and,
a cone extending from the flange and communicating with the interior of the structure through the structural opening at a wide, first end and with the outside atmosphere at a narrow, opposite end;
the device being made of slippery material

2. The device of claim 1 wherein the device is made of soft pliable material.

3. The device of claim 1 wherein the device is made of rigid material.

4. The device of claim 1 wherein flange and cone are one piece.

5. The device of claim 1 wherein flange and cone are separate pieces.

6. The device of claim 5 wherein the flange is provided with an opening, the cone being provided with an annular portion surrounding the wide, first end and the flange is press fit over the cone and against the annular portion.

7. The device of claim 1 wherein the cone is of oblong cross section.

8. The device of claim 1 wherein the base of the cone has a bellows-like portion.

9. The device of claim 6 wherein the cone is of oblong cross section.

10. The device of claim 6 wherein the base of the cone has a bellows-like portion.

11. The device of claim 1 including an opening reducing piece for insertion into the cone at its narrow opposite end.

12. The device of claim 1 wherein the device is made of clear material.
